(19) United States
(12) Patent Application Publication
(10) Pub. No.: US 2024/0164562 A1
(43) Pub. Date: May 23, 2024

(54) Ornament and Method of Assembly

(71) Applicant: BAUBLEBAR, INC., New York, NY (US)

(72) Inventors: DANIELLE ANN ROEVER, Darien, CT (US); ERIN LYNN SOUDER, Columbus, OH (US); AMY JAIN PATEL, Brooklyn, NY (US)

(73) Assignee: BAUBLEBAR, INC., New York, NY (US)

(21) Appl. No.: 17/993,206

(22) Filed: Nov. 23, 2022

(51) Int. Cl. A47G 33/08

(52) U.S. Cl. CPC A47G 33/08

(57) ABSTRACT

A ornament, preferably replicating or resembling a candy cane, in which two parts are secured together by a bar and received and arrayed on the bar between the two parts are received components, preferably including alphanumeric character beads and spacer beads.

The present disclosure generally relates to ornaments and the like. More particularly, it relates to ornaments that can be assembled.

### SUMMARY

The present disclosure describes one or more embodiments of one or more inventions relating to ornaments.

In an embodiment, there is provided an article of manufacture comprising:

a first part resembling or replicating at least a handle portion of a cane, preferably a candy cane;
a second part resembling or replicating a portion of the shaft of the cane;
a bar connecting together the first part and the second part, the bar having an axis; and components received on the bar and arrayed along the axis and positioned between the first part and the second part.

In an embodiment, the components comprise first type components and second type components, the first type components being alphanumeric characters and the second type components being spacers.

In an embodiment, the bar is cylindrical.

In an embodiment, the bar is non-cylindrical.

In an embodiment, the bar is coated with an enamel.

In an embodiment, the bar has a first cross sectional area perpendicular to the axis that is less than a second cross-sectional area perpendicular to the axis of either the first part or the second part.

In an embodiment, the components have openings through with the bar extends with inner peripheries that conform in shape to an outer cross sectional periphery of the bar.

In an embodiment, the components are friction fitted on the bar.

In an embodiment, the first type components, the second type components, or both, have inner peripheries with a non-slip material.

In an embodiment, the non-slip material is a rubber coating.

In an embodiment, the non-slip materials is a plastic.

In an embodiment, a first end of the bar is permanently secured within the second part.

In an embodiment, a second end of the bar is removably secured within the first part.

In an embodiment, the second end of the bar and the first part are secured together with a friction fit.

In an embodiment, the second end of the bar is threaded and the bar is threadingly received within the first part.

In an embodiment, the second part includes a locking nut.

In an embodiment, the second part includes a nylon insert.

In an embodiment there is provided a method comprising:

providing an article of manufacture comprising: a first part that resembles or replicates at least a portion of a handle of a cane, preferably a candy cane, a second part that resembles or replicates a portion of a shaft of the cane; and a bar configured to secure together the first part and the second part, the bar having a longitudinal axis, a first end of the bar secured to the second part;
providing components to be received on the bar and arrayed along the axis and positioned between the first part and the second part;
placing the components on the bar so as to be arrayed along the axis; and securing a second end of the bar to the second part.

In an embodiment of the method, the components comprise first type components and second type components, the first type components being alphanumeric characters and the second type components being spacers.

In an embodiment of the method, the bar is cylindrical.

In an embodiment of the method, the bar is non-cylindrical.

In an embodiment of the method, the bar is coated with an enamel.

In an embodiment of the method, the bar has a first cross sectional area perpendicular to the axis that is less than a second cross-sectional area perpendicular to the axis of either the first part or the second part.

In an embodiment of the method, the components have openings through with the bar extends with inner peripheries that conform in shape to an outer periphery of the bar.

In an embodiment of the method, the components are friction fitted on the bar.

In an embodiment of the method, the first type components, the second type components, or both, have inner peripheries with a non-slip material.

In an embodiment of the method, the non-slip material is a rubber coating.

In an embodiment of the method, the non-slip materials is a plastic.

In an embodiment of the method, a first end of the bar is permanently secured within the second part.

In an embodiment of the method, a second end of the bar is removably secured within the first part.

In an embodiment of the method, the second end of the bar and the first part are secured together with a friction fit.

In an embodiment the method, the second end of the bar is threaded and the bar is screwed into the first part.

In an embodiment of the method, the first part includes a locking nut.

In an embodiment of the method, the first part includes a nylon insert.

In an embodiment of the method, a replica of a candy cane is created.

Other features and advantages of the one or more disclosed inventions will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the system disclosed herein, and together with the description, explain the advantages and principles of the disclosed system. In the drawings:

FIG. 1 illustrates a front side view of a first ornament embodying principles disclosed herein.

FIG. 2 illustrates a first side view of the ornament of FIG. 1.

FIG. 3 illustrates a second side view of the ornament of FIG. 1.

FIG. 4 illustrates a back side view of the ornament of FIG. 1.

FIGS. 5A and 5B illustrate a first type component for the ornament of FIG. 1.

FIGS. 6A and 6B illustrate a second type component for the ornament of FIG. 1.

FIG. 7 illustrates portions of the ornament of FIG. 1 without components.

FIG. 8 Illustrates a first arrangement for securing together parts of the ornament of FIG. 1.

FIG. 9 Illustrates a second arrangement for securing together parts of the ornament of FIG. 1.

FIGS. 10A and 10B Illustrate a third arrangement for securing together parts of the ornament of FIG. 1.

FIG. 11 illustrates a front side of a second ornament embodying principles disclosed herein.

FIGS. 12A and 12B illustrate a first type component for the ornament of FIG. 11.

FIGS. 13A and 13B illustrate a second type component for the ornament of FIG. 11.

FIG. 14 illustrates a front side of a third ornament embodying principles disclosed herein.

FIGS. 15A and 15B illustrate a first type component for the ornament of FIG. 14.

FIGS. 16A and 16B illustrate a second type component for the ornament of FIG. 14.

### DETAILED DESCRIPTION

Reference will now be made in detail to one or more implementations or embodiments using one or more prefabricated modular composite panels consistent with the principles disclosed herein with reference to the accompanying drawings.

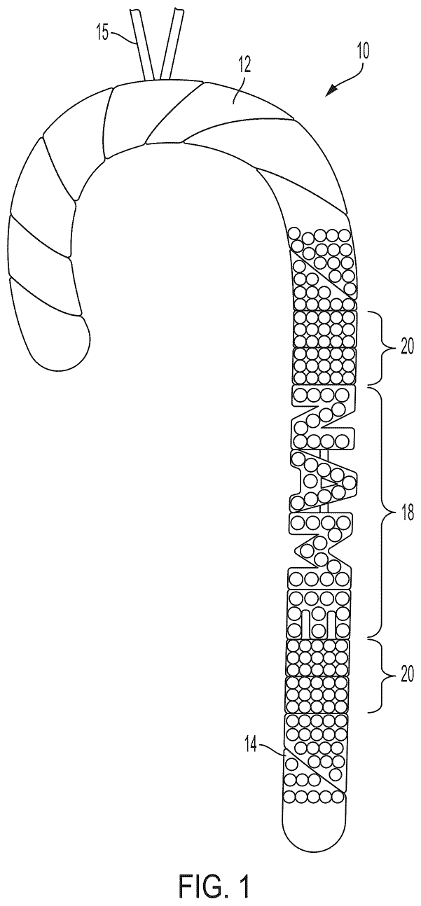

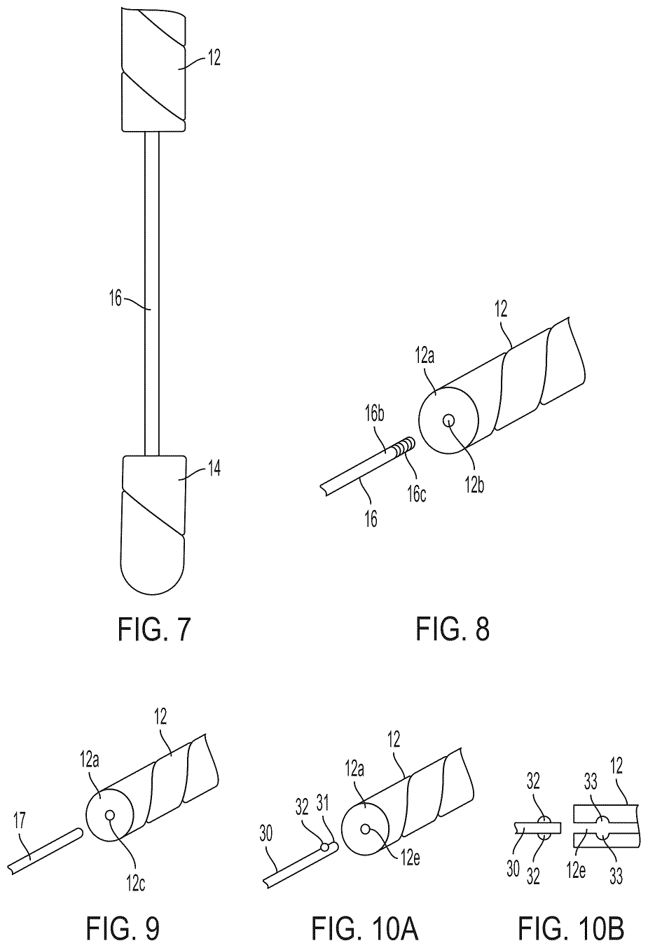

FIGS. 1-4 illustrate an ornament 10 which resembles or replicates a cane with a first part 12 resembling or replicating a handle portion of the cane and a second part 14 resembling or replicating a shaft portion of the cane. The ornament or cane 10 includes a bar 16 (shown in FIGS. 7 and 8) upon which are received first type components 18 and second type components 20. Collectively and generically, the first type components and second type components can be referred to simply as components.

In preferred embodiments, the first type components 18 comprise alphanumeric beads that are arrayed along an axis of the bar 16. In the illustrated embodiment, the first type components 18 spell out the word “NAME,” however, preferably they can spell out any word including personal names. The second type components 20 preferably are short cylindrical or flat round beads that can act as spacers to center the first type components 18 along the bar 16 between the handle portion 12 and the shaft portion 14, and to fill gaps that can occur between the first type components 18 and the first part 12 and the second part 14.

The ornament 10 includes an eyelet 13 for receipt of a hanger member 15, e.g., a filament, thread, string, ribbon, wire, or hook, preferably a metallic gold thread. The eyelet can be made of a metal and secured in place during casting of the first part 12 thereby to be permanently securing the eyelet 13 in place.

FIGS. 5A and 5B illustrate a typical first type component 18, in this case a letter “N” pave bead 18. In FIG. 5A, the component 18 is shown from its front face side 18A, i.e., perpendicular to the axis of the bar 16. In FIG. 5B, the component 18 is shown from a lateral side 18B, i.e., along the axis of the bar 16. As can be seen, the component 18, as would be true for all components 18, includes a through hole 19 through which can extend the bar 16. Preferably, the through hole 19 is lined with a suitable non-slip material such as a rubber or nylon material to prevent excessive sliding or slipping of the component along the bar 16 and rotation of the component 18 about the bar 16.

If the bar 16 has a cross section shape that is other than circular, e.g., rectangular or triangular, the through hole 19 can have a matching or mating cross-sectional shape. Using non-circular cross-section shapes can further prevent rotation of the component 18 about the bar 16.

FIGS. 6A and 6B illustrate a typical second type component 20, in this case a cylindrical flat round pave bead 20. In FIG. 6A, the component 20 is shown from its front face side 20A, i.e., perpendicular to the axis of the bar 16. In FIG. 6B, the component 20 is shown from a lateral side 20B, i.e., along the axis of the bar 16. As can be seen, the component 20, as would be true for all components 20, includes a through hole 21 through which can extend the bar 16. Preferably, the through hole 21 is lined with a suitable non-slip material such as a rubber or nylon material to prevent excessive sliding or slipping of the component along the bar 16.

If the bar 16 has a cross section shape that is other than circular, e.g., rectangular or triangular, the through hole 21 can have a matching or mating cross-sectional shape. Using non-circular cross-section shapes can further prevent rotation of the component 20 about the bar 16.

As can be seen best in FIGS. 1-4, the first part 12 and the second part 14 preferably have circular cross sections with equal diameters. However, in other embodiments, the cross sections can be of other shapes, e.g., rectangular or triangular. As can also be seen, preferably the cross sections of the first part 12 and the second part 14 are of equal maximum dimensions, e.g., equal diameters for circular cross sections.

As can be seen best in FIGS. 1-4, the second type components 20 preferably have cross sections that are the same as those of the first part 12 and the second part 14, both in shape and dimensions. Thus, in this preferred embodiment, the first part 12, the second part 14, and the second type components 20 have cross sections orthogonal to the axis of the bar 16 that are circular and of equal, or nearly equal diameters.

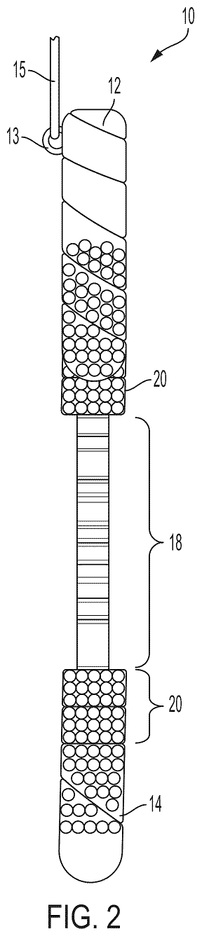

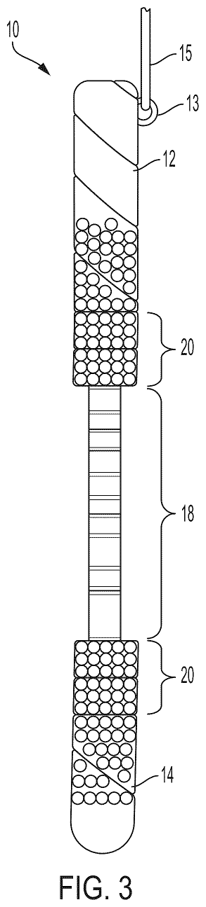

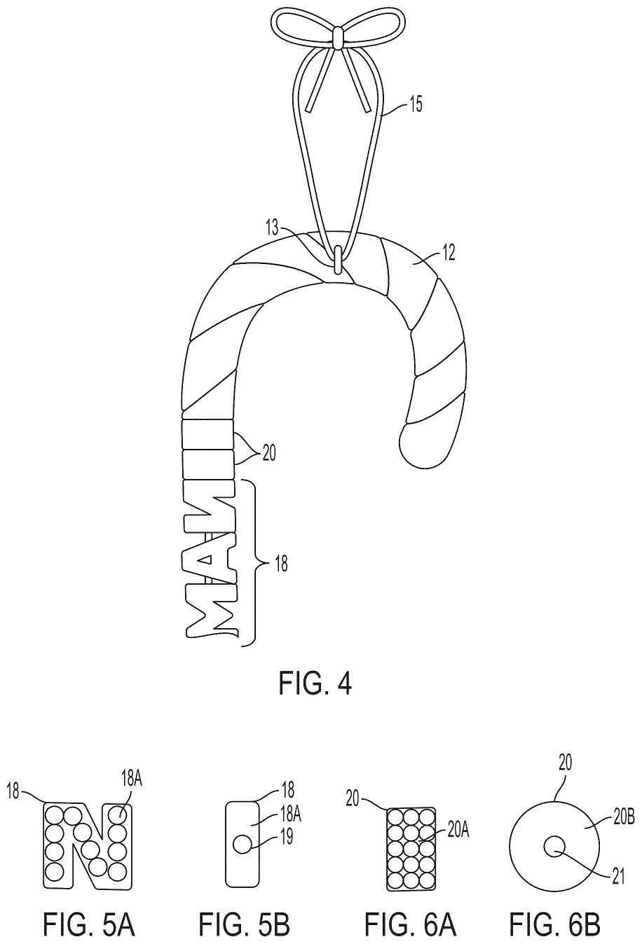

As can be seen best in FIGS. 1 and 4, the first type components 18 preferably have an overall height dimension orthogonal the axis of the bar 16 that is equal or nearly equal to the maximum front and back cross section dimensions of the first part 18 and the second part 20. As such, the ornament has an effectively overall same maximum dimension in one direction orthogonal to the axis of the bar 16. However, as can be seen best in FIGS. 2 and 3, the first type components 18 preferably have a thickness dimension orthogonal to the axis of the bar 16 and orthogonal to the height dimension that is less than the maximum cross sectional dimension of the first part 18 and the second part 20 such that the first type components are not unduly large compared to overall ornament 10.

The second part 14 of the ornament 10 preferably includes helical striping comprised of alternating stripes of pave sections, preferably of different stones or colors. The second type components 20 preferably are flat round pave beads. The first type components preferably comprise pave letter beads. The first part 12 also comprises pave helical stripes, which may be of a same or different stones or colors.

As can be seen in FIG. 7, the bar 16 is used to join and secure together first part 12 and second part 14. In this view, no components are received on the bar 16. Preferably, a first end (not visible) of the bar 16 is embedded and permanently secured in the second part 14 when the second part 14 is cast.

As can be seen in FIG. 8, the bar 16 includes a second end 16b that has threading 16c. The first part 12 has an end 12a that includes a threaded hole 12b to threadingly receive the second end 16b of the bar 16. In this embodiment, the bar 16 can be called a screw bar. As can be appreciated, the more the bar 16 is screwed into the first part 12, the closer the first part 12 and the second part 14 become. As a result, when the components 18 and 20 are received on the bar 16 and the ornament 10 is assembled, given use of an appropriate number of second type components 20, the components 18 and 20 can be held tightly against each other when the bar 16 is sufficiently screwed into the first part 12. This can further prevent rotation of the components around the bar 16.

FIG. 9 illustrates an alternate bar 17 without threads at the end that is received within a first part 12. In this embodiment, the first part 12 includes a hole 12c with a non-slip lining, e.g., a rubber lining or glue. The bar 17 then is inserted as deep into the hole 12c as desired until the components 18 and 20 are held sufficiently tight between the first and second parts of the ornament, in this case a cane handle and a can shaft portion, so as to be restricted from rotating about the bar 17 or sliding along the bar 17.

FIGS. 10A and 10B illustrate another alternate bar 30 that includes one or more spring loaded buttons 32 at the end 31 of the bar 30. These buttons 32 can be received within suitable concavities 33 within a hole 12e in a first part 12. In this embodiment, the bar 30 becomes fixed relative to the first part 12 so the spacings between the components mounted on the bar 30 are controlled by the number of the second type components 20 used.

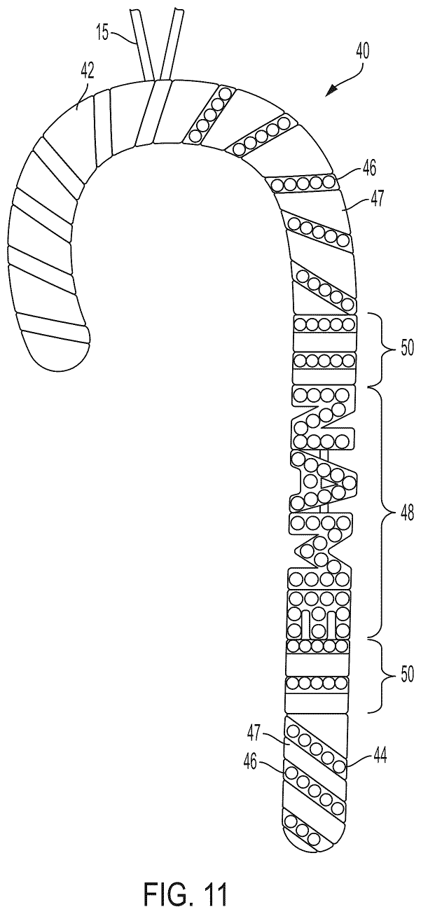

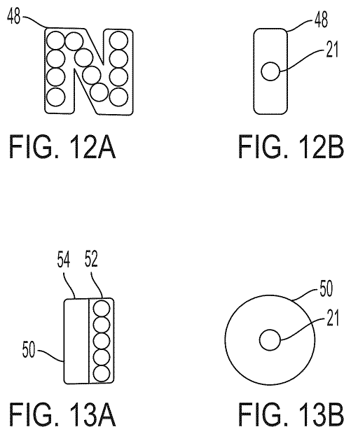

FIGS. 11-13B, illustrate a second ornament 40, with a first part 42, preferably resembling or replicating a handle of a cane, preferably a candy cane, and a second part 44, preferably resembling or replicating a portion of a shaft of the cane. Since in all major aspects ornament 40 is the same as or similar to the ornament 10, those aspects are not further discuss herein. Ornament 40 has first type components 48 and second type components 50, but differs from ornament 10 in its external surface ornamentation. Components 48 and 50 may also differ from components 18 and 20, respectively in their external surface ornamentations.

In this embodiment, the second type components 50 preferably comprise flat round pave beads with an outer circumference half 52 of which comprises paving, the other half 54 of which comprises enamel. The first type components 48 preferably comprise alphanumeric beads with pave front and back sides. The first part 42 and the second part 44 preferably comprise alternating helical pave stripes and enamel painted stripes.

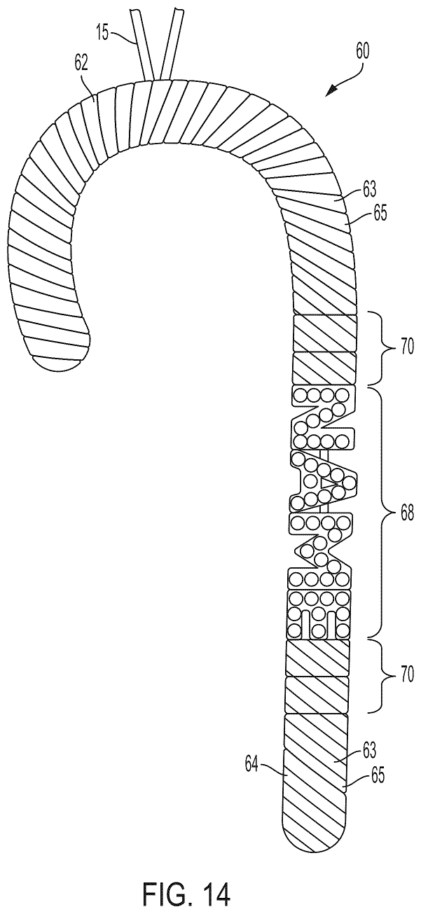

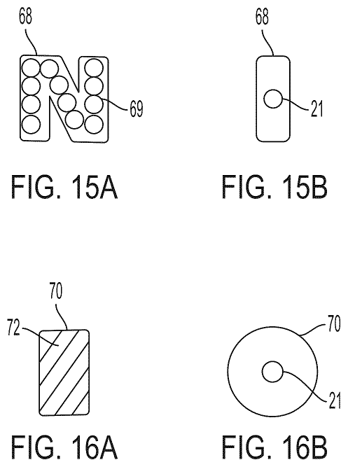

FIGS. 14-16B illustrate a third ornament 60, with a first part 62, preferably resembling or replicating a handle of a cane, preferably a candy cane, and a second part 64, preferably resembling or replicating a portion of a shaft of the cane. Since in all major aspects ornament 60 is the same as or similar to the ornament 10 and the ornament 40, those aspects are not further discuss herein. Ornament 60 has first type components 68 and second type components 70 and differs from ornaments 10 and 40 in its external surface ornamentation. Similarly, components 68 and 70 differ from components 18 and 48 and 20 and 50, respectively in external surface ornamentation.

In this embodiment, the second type components 70 preferably comprise flat round beads with an outer circumference 72 comprised of painted enamel stripes. The first type components 68 preferably comprise alphanumeric beads with pave front and back sides. The first part 62 and the second part 64 preferably comprising helical enamel painted stripes painted with different colors.

In these embodiments, the bar 16, 17, or 30 preferably is made of a metal, preferably steel. The bar can be coated with enamel, preferably colored white. The first part 12 replicating cane handle and the second part 14 replicating a portion of a cane shaft are made of a cast material, preferably zinc.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

This detailed description has been presented for various purposes of illustration and description, but is not intended to be fully exhaustive and/or limited to this disclosure in various forms disclosed. Many modifications and variations in techniques and structures will be apparent to skilled artisans, without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

1. An ornament comprising:
a first part replicating in shape a curved handle of a candy cane, the first part made of a cast material;
a second part replicating in shape a portion of a shaft of the candy cane, the second part made of the cast material and having an end replicating an end of the shaft of the candy cane;
a bar connecting together the first part and the second part, the bar being straight and having an axis, the bar being distinct from the first part and the second part, the bar being releasably secured to at least the first part or the second part, the bar having a first cross sectional area perpendicular to the axis that is less than a second cross-sectional area perpendicular to the axis of each of the first part and the second part, and
components received on the bar and arrayed along the axis and positioned between the first part and the second part.

2. The ornament of claim 1, wherein the components comprise first type components and second type components, the first type components being alphanumeric characters and the second type components being spacers.

3. The ornament of claim 1, wherein the bar is cylindrical.

4. The ornament of claim 1, wherein the bar is non-cylindrical.

5. The ornament of claim 1, wherein the bar is coated with an enamel.

6. The ornament of claim 1, wherein the components have openings through which the bar extends, the openings having inner peripheries that are approximately a same shape as an outer periphery of the bar.

7. The ornament of claim 2, wherein the first type components, the second type components, or both, have inner peripheries with a non-slip material.

8. The ornament of claim 7, wherein the non-slip material is a rubber coating.

9. The ornament of claim 1, wherein a second end of the bar is removably secured within the first part.

10. The ornament of claim 1, wherein the second end of the bar is threaded and the bar is threadingly received within each of the first part and the second part.

11.-20. (canceled)

21. The ornament of claim 1, wherein the cast material comprises zinc.

22. The ornament of claim 1, wherein the bar is made of metal.

23. The ornament of claim 22, wherein the bar is made of stainless steel.

24. The ornament of claim 23, wherein the cast material consists essentially of zinc.

25. The ornament of claim 22, wherein the bar is coated with enamel.

26. The ornament of claim 23, wherein the bar is coated with enamel.

27. An ornament comprising:
a first part replicating in shape a curved handle of a candy cane, the first part made of a cast material consisting essentially of zinc;
a second part replicating in shape a portion of a shaft of the candy cane, the second part made of the cast material and having an end replicating an end of the shaft of the candy cane;
a metal bar connecting together the first part and the second part, the bar being straight and having an axis, the bar being distinct from the first part and the second part, the bar being releasably secured to at least the first part or the second part, the bar having a first cross sectional area perpendicular to the axis that is less than a second cross-sectional area perpendicular to the axis of each of the first part and the second part; and
alphanumeric components received on the bar and arrayed along the axis and positioned between the first part and the second part.
